(19) United States
(12) Patent Application Publication
(10) Pub. No.: US 2009/0076728 A1
(43) Pub. Date: Mar. 19, 2009

(54) AIRCRAFT TERRAIN AVOIDANCE AND ALARM METHOD AND DEVICE

(75) Inventors: Christophe Bouchet, Toulouse (FR); Jean-Pierre Demortier, Maurens (FR)

Correspondence Address: Dickinson Wright PLLC;James E. Ledbetter, Esq., International Square, 1875 Eye Street, NW., Suite 1200, WASHINGTON, DC, 20006, US

(73) Assignee: AIRBUS FRANCE, TOULOUSE (FR)

(21) Appl. No.: 11/719,134

(22) PCT Filed: Nov. 10, 2005
(86) PCT No.: PCT/FR05/02803

§ 371 Date: May 11, 2007

(30) Foreign Application Priority Data
Nov. 15, 2004 (FR) 0412067

(51) Int. Cl. G08G 1/16; G08B 21/00

(52) U.S. Cl. 701/301; 340/945

(57) ABSTRACT

The device (1) comprises a first means (2) knowing the profile of the terrain at least that which is located at the front of the aircraft, a second means (3) for determining an avoidance trajectory, a third means (4) which is connected to the first and second means (2, 3) and used to verify if there is a terrain collision risk for the aircraft, a fourth means (7) for emitting an alarm signal in the event of detection of a collision risk by the third means (4), at least one aircraft performance data base (Bi) relating to an avoidance maneuvering gradient which can be flown by the aircraft according to particular flight parameters, and a fifth means (9) for determining the effective values of the particular parameters during the flight of the aircraft, wherein the third means (3) is formed in such a way that it is possible to determine the avoidance trajectory according to the information received from the data base (Bi) and the fifth means (9).

The present invention relates to an aircraft terrain avoidance and alarm method and device, in particular for a transport plane.

It is known that such a device, for example of TAWS type (“Terrain Avoidance and Warning System”) or of GPWS type (“Ground Proximity Warning System”) is aimed at detecting any risk of collision of the aircraft with the surrounding terrain and at warning the crew when such a risk is detected, so that the latter can then implement a terrain avoidance maneuver. Such a device generally comprises:
a first means knowing the profile of the terrain at least in front of the aircraft;
a second means for determining an avoidance trajectory of the aircraft;
a third means connected to said first and second means, for verifying whether there exists a risk of collision of the terrain for the aircraft; and
a fourth means for issuing an alarm signal, in case of detection of a risk of collision by said third means.

Generally, said second means determines the avoidance trajectory (which is taken into account by the third means so as to detect a risk of collision with the terrain), by using a slope exhibiting a fixed and invariable value, in general 6° for a transport plane, regardless of the type of aircraft and regardless of its actual performance.

Of course, such a mode of calculation exhibits the risk of underestimating or overestimating the actual performance of the aircraft, this possibly causing overly late detections of risks of collision or false alarms. This mode of calculation is therefore not completely reliable.

Document EP-0 750 238 discloses a terrain avoidance device of the aforesaid type. This known device makes provision to determine two trajectories which are subsequently compared with the profile of the terrain overflown, one of said trajectories representing the predicted effective trajectory of the aircraft and the other trajectory possibly corresponding in particular to a predicted climb trajectory. This prior document makes provision to take account of maneuvering capabilities of the aircraft to predict these trajectories, without however indicating the way in which these trajectories are actually calculated or predicted.

The present invention relates to a aircraft terrain avoidance and alarm method, which makes it possible to remedy the aforesaid drawbacks.

For this purpose, according to the invention, said method is noteworthy in that:
I) in a preliminary step, at least one database of performance of the aircraft is formed, which performance relates to an avoidance maneuver slope flyable by the aircraft, as a function of particular flight parameters; and
II) in the course of a subsequent flight of the aircraft:
   a) the effective values of said particular flight parameters are determined;
   b) an avoidance trajectory is determined on the basis of these effective values of said particular flight parameters and of said database;
   c) with the aid of said avoidance trajectory and of the profile of the terrain situated at least in front of the aircraft, a check is made to verify whether there is a risk of collision with said terrain for said aircraft; and
   d) in case of risk of collision, a corresponding alarm signal is issued.

Thus, by virtue of the invention, instead of using as stated above a fixed and invariant slope value, the avoidance trajectory is determined by taking account of the actual performance of the aircraft, by virtue of the characteristics of said database and by virtue of the measurements of said effective values. Consequently, the detection of a risk of collision with the terrain takes account of the effective capabilities of the aircraft, thereby making it possible in particular to avoid false alarms and to obtain particularly reliable monitoring. It will be noted that document EP-0 750 238 mentioned above does not make provision to determine and to use a slope (for an avoidance trajectory) which depends on the effective values of particular flight parameters.

Advantageously, to form said database, a plurality of values is determined for said slope, which are representative on each occasion of different values as regards said flight parameters. Preferably, said flight parameters comprise at least some of the following parameters of the aircraft:
its mass;
its speed;
its altitude;
the ambient temperature;
its centering;
the position of its main landing gear;
the aerodynamic configuration;
the activation of an air-conditioning system;
the activation of an anti-icing system; and
a possible failure of an engine.

Furthermore, advantageously, for at least one flight parameter, a predetermined fixed value is used to form said database, thereby making it possible to reduce the size of the database. In this case, preferably, use is made, as predetermined fixed value for a flight parameter, of the value of this flight parameter which exhibits the most unfavorable effect on the slope of the aircraft. By way of example, the centering of the aircraft can be fixed at the front limit value which is the most penalizing.

In a preferred embodiment, use is made, for the speed, of a stabilized minimum speed that is known and that the aircraft normally flies at during a standard terrain avoidance procedure following an alarm of risk of collision, that is to say a fixed value corresponding to a speed-wise protection value for flight controls of the aircraft.

In a variant applied to the monitoring of a low-altitude flight of an aircraft, use is advantageously made, for the speed, of a predetermined value corresponding to a speed of best slope, and not to a minimum speed as in the previous example.

Additionally, to form said database, in case of failure of an engine, the slope of the aircraft is deduced from a minimum slope representative of normal operation (failure-free) of all the engines of the aircraft and to which is applied a deduction dependent on said nominal failure. Preferably, said deduction is calculated by means of a polynomial function modeling said nominal slope (slope of the aircraft with all engines operational).

The present invention also relates to an aircraft terrain avoidance and alarm device, in particular for a transport plane, said device being of the type comprising:
a first means knowing the profile of the terrain at least in front of the aircraft;
a second means for determining an avoidance trajectory;
a third means connected to said first and second means, for verifying whether there exists a risk of collision of the terrain for the aircraft; and
a fourth means for issuing an alarm signal, in case of detection of a risk of collision by said third means.

It is known that generally said second means determines the avoidance trajectory, by calculating an avoidance slope at the current speed of the aircraft, which is greater than a minimum speed that the aircraft normally flies at during a standard terrain avoidance procedure following an alarm. Consequently, this avoidance slope is different from the slope which will actually be flown during the maneuver. Such a mode of calculation can be the cause of erroneous alarms, by initially underestimating the actual performance of the aircraft.

In particular to remedy these drawbacks, said device of the aforesaid type is noteworthy, according to the invention, in that it moreover comprises at least one database of performance of the aircraft, relating to an avoidance maneuver slope flyable by the aircraft, as a function of particular flight parameters, and a fifth means for determining in the course of a flight of the aircraft the effective values of said particular parameters, and in that said second means is formed in such a way as to determine said avoidance trajectory, as a function of cues received respectively from said database and from said fifth means.

The design of said database therefore takes account of a predictive capability as regards the climb performance of the aircraft so as to avoid the terrain. Moreover, the speed of the avoidance phase being predetermined (at a minimum speed, as specified hereinbelow) so as to subsequently provide the associated slope, one thus dispenses with the current speed of the aircraft (which is necessarily greater than said minimum speed), thereby making it possible to stabilize the avoidance slope calculated by the device in accordance with the invention and thus to avoid false alarms.

In a particular embodiment, the device in accordance with the invention comprises a plurality of such databases relating respectively to various categories of aircraft and a means of selection for selecting, from among these databases, the one which relates to the aircraft on which said device is mounted, said second means using cues from the database thus selected to determine said avoidance trajectory.

Each of said categories comprises:
either a single type of aircraft;
or a set of types of aircraft exhibiting for example substantially equivalent performance and grouped together into one and the same category.

The figures of the appended drawing will elucidate the manner in which the invention may be embodied. In these figures, identical references designate similar elements.

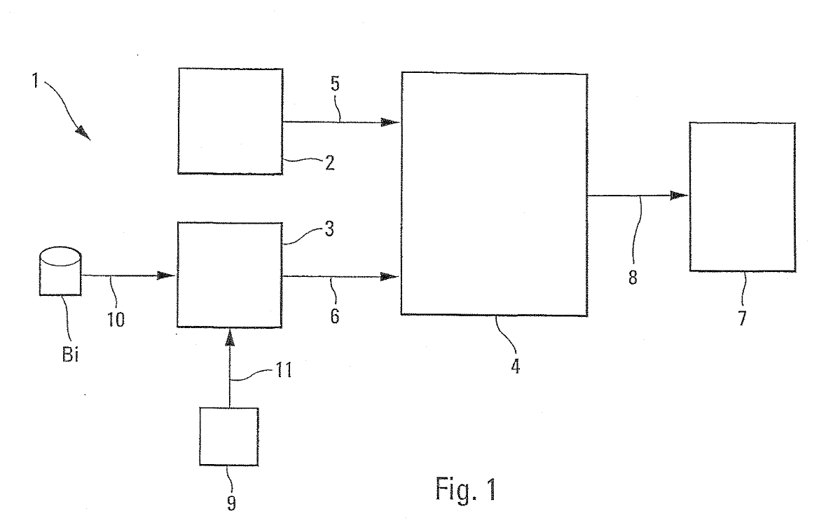

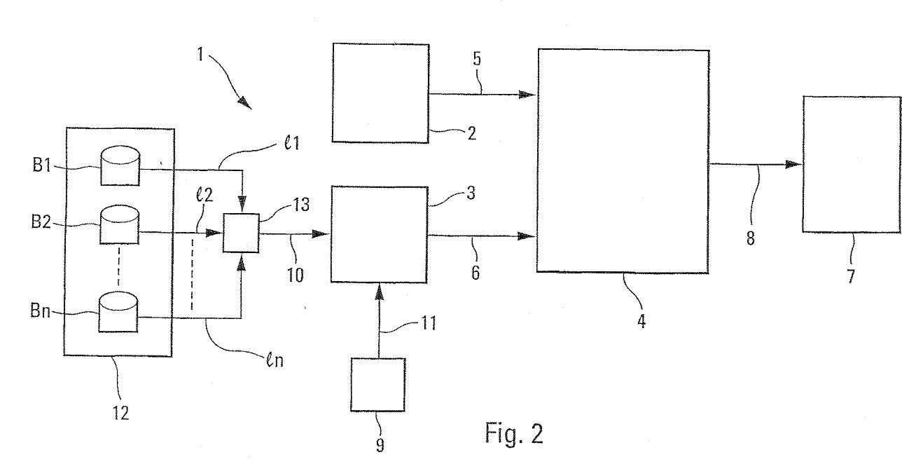

FIGS. 1 and 2 are the schematic diagrams of two different embodiments of a terrain avoidance and alarm device in accordance with the invention.

The device 1 in accordance with the invention and represented diagrammatically in FIGS. 1 and 2 is aimed at detecting any risk of collision of an aircraft, in particular a transport plane, with the surrounding terrain and at warning the crew of the aircraft when such a risk is detected, so that the latter can then implement a terrain avoidance maneuver.

Such a device 1, for example of TAWS type (“terrain avoidance and warning system”) or of GPWS type “ground proximity warning system”), which is carried onboard the aircraft, comprises in standard fashion:
a means 2 which knows the profile of the terrain at least in front of the aircraft and which for this purpose comprises for example a database of the terrain and/or a means for detecting the terrain such as a radar;
a means 3 for determining an avoidance trajectory;
a means 4, which is connected by way of links 5 and 6 to said means 2 and 3, for verifying in a standard fashion whether there exists a risk of collision of the terrain for the aircraft, on the basis of the cues transmitted by said means 2 and 3; and
a means 7 which is connected by way of a link 8 to said means 4, for issuing an alarm signal (audible and/or visual), in case of detection of a risk of collision by said means 4.

According to the invention:
said device 1 furthermore comprises:
   at least one database Bi, B1, B2, Bn of performance of the aircraft, which performance relates to an avoidance maneuver slope flyable by the aircraft, as a function of particular flight parameters, as specified hereinbelow; and
   a means 9 for determining in the course of a flight of the aircraft the effective values of said particular flight parameters; and
said means 3 is connected by way of links 10 and 11 respectively to said database Bi, B1, B2, Bn and to said means 9 and is formed in such a way as to determine said avoidance trajectory, as a function of the cues received both from said database Bi, B1, B2, Bn and from said means 9, as specified hereinbelow.

Moreover, according to the invention, said database Bi, B1, B2, Bn is formed on the ground during a preliminary step, before a flight of the aircraft, in the manner specified hereinbelow.

In particular, to form said database Bi, B1, B2, Bn, a plurality of values of said slope is determined, representative respectively of a plurality of different values as regards said flight parameters. These flight parameters comprise parameters relating to flight characteristics (speed, mass, etc.) of the aircraft, parameters relating to systems (air conditioning, anti-icing, etc.) of the aircraft, and parameters relating to the environment (temperature), outside the aircraft. Preferably, said flight parameters comprise at least some of the following parameters relating to the aircraft:
the mass of the aircraft;
the speed of the aircraft;
the altitude of the aircraft;
the ambient temperature;
the centering of the aircraft;
the position of the main landing gear of the aircraft;
the aerodynamic configuration (that is to say the position of slats and flaps on the wings in the case of a plane);
the activation (or nonactivation) of a standard air-conditioning system of the aircraft;
the activation (or nonactivation) of a standard anti-icing system of the aircraft; and
a possible failure of an engine of the aircraft.

In a particular embodiment, said slope is calculated in standard fashion, as a function of said flight parameters, on the basis of standard documentation for the performance of the aircraft (for example the flight manual), which arises out of models rejigged through flight trials.

Furthermore, for at least one of the aforesaid flight parameters, a predetermined fixed value is used to form said database Bi, B1, B2, Bn, thereby making it possible to reduce the size of the database Bi, B1, B2, Bn. In this case, preferably, use is made, as predetermined fixed value for a flight parameter, of the value of this flight parameter which exhibits the most unfavorable effect on the slope of the aircraft. By way of example, the centering of the aircraft can be fixed at the front limit value which is the most penalizing, and the air-bleed configurations (anti-icing and air conditioning) may be fixed in such a way as to remain conservative vis-à-vis the performance of the aircraft.

In a preferred embodiment, use is made, for the speed, of a fixed value corresponding to a speed-wise protection value for flight controls of the aircraft, that is to say a minimum speed that the aircraft normally flies at during a standard terrain avoidance maneuver following an alarm, for example a speed Vαmax (speed at maximum angle of incidence) or a speed VSW (of the “stall warning” type). More precisely, it is known that for aircraft, whose flight envelope is protected from stalling by standard computers, a standard avoidance maneuver leads to the aircraft being brought onto a climb slope corresponding to a minimum speed which is maintained by these computers so that the aircraft will not be able to go beyond the angle of incidence corresponding to this minimum speed. It is therefore this climb slope (stabilized) which has been determined initially for all possible conditions defined by the configurations of the aforesaid flight parameters (other than the speed) and has subsequently been modeled in such a way as to be integrated into the database Bi, B1, B2, Bn.

Thus, by virtue of the invention:
the design of the database Bi, B1, B2, Bn introduces a predictive capability, since the speed of the avoidance phase is predetermined so as to subsequently provide the associated slope. One thus dispenses with the current speed of the aircraft (which is necessarily greater than this minimum speed), thereby making it possible to stabilize the avoidance slope calculated by the device 1. Without this modeling, the device 1 ought to calculate an avoidance slope at the current speed of the aircraft, this avoidance slope would therefore be different from the slope actually flown during the maneuver (and would then tend toward this latter slope, in tandem with the deceleration of the aircraft). This type of calculation could cause erroneous alarms, by initially underestimating the actual performance of the aircraft. The aforesaid modeling in accordance with the present invention therefore makes it possible to provide a calculation slope which is stable for the device 1 (by integrating the speed of calculation of the slope) and thus to avoid false alarms;
the integration of this parameter (speed) makes it possible to considerably decrease the size of the database Bi, B1, B2, Bn;
the database Bi, B1, B2, Bn is constructed on regulatory bases (the slopes at minimum speed being certified data), thereby making it possible to be able to readily formulate a process for generating data which complies with a “DO-200A” standard (and which is therefore qualifiable with respect to this standard) guaranteeing the level of integrity of the databases.

It will be noted moreover that a complementary solution of the present invention aims at modeling the maximum slopes flyable with engine failure(s), on the basis of the slope with all engines operational, and the addition of a (negative) slope deduction Δp which is modeled by a polynomial function. This modeling makes it possible to significantly reduce the size of the memory intended to receive the database Bi, B1, B2, Bn (memory size reduced by a coefficient 2 or 3 in principle). This slope deduction Δp can be expressed in the form:

Δp=K1.PO+K2

in which:
PO corresponds to the slope with all engines operational; and
K1 and K2 represent constants which are applicable to a whole family of aircraft of similar geometry.

An extrapolated application of the invention described hereinabove may also be envisaged for a function of monitoring a low-altitude flight of an aircraft. The major difference as compared with the previous description is to do with the fact that the slopes modeled are no longer modeled for minimum speeds, but for slopes at a particular speed that is indicated hereinafter (with the condition: a failed engine). This time the aim of the modeling is to make the flight of the aircraft safe (during low-altitude flight) vis-à-vis an engine failure. Unlike the aforesaid terrain collision avoidance procedure, the procedure applicable in the case of an engine failure (during low-altitude flight) is aimed at bringing the aircraft to a speed of best slope. The expression a speed of best slope is understood to mean the speed which makes it possible to attain a maximum of altitude for a minimum distance, doing so without departing from the speed flight domain. On the other hand, the aforesaid principles remain the same, since the speed of best slope is a speed which is predetermined, as a function of at least some of the aforesaid flight parameters (mass, altitude, etc.).

It will be noted that the performance database Bi, B1, B2, Bn makes it possible to calculate in real time the aircraft's capabilities of avoiding, by going above it, any obstacle which lies ahead of it and/or along the flight plan followed. Thus, the device 1 in accordance with the invention determines the avoidance trajectory by taking account of the effective performance of the aircraft, by virtue of the characteristics of said database Bi, B1, B2, Bn and by virtue of the measurements of said effective values. Consequently, the detection of a risk of collision with the terrain takes account of the effective capabilities of the aircraft, thereby making it possible in particular to avoid false alarms and to obtain particularly reliable monitoring.

In a particular embodiment represented in FIG. 2, the device 1 in accordance with the invention comprises:
a set 12 of databases B1, B2, . . . , Bn which relate respectively to n different categories of aircraft, n being an integer greater than 1; and
a means of selection 13 which is connected by links l1, l2 to ln to said databases B1, B2 to Bn respectively and which is intended to select, from among these databases B1, B2 to Bn, the one which relates to the aircraft on which said device 1 is mounted. Said means 3 which is connected by the link 10 to said means of selection 13 uses solely cues from the database selected by said means of selection 13 to determine said avoidance trajectory.

Each of said categories of aircraft comprises either a single type of aircraft (a category then corresponds to a type), or a set of types of aircraft exhibiting for example substantially equivalent performance and grouped together into one and the same category (each category then comprises several types).

Preferably, the selection of the database representative of the aircraft, which is implemented by the means of selection 13, is carried out by a pin programming (that is to say with terminals of a connector between the aircraft and the device 1, corresponding to 0 or 1 logic levels depending on the category of aircraft). This makes it possible to have a single type of equipment (device 1) for all the aircraft of different categories (or types) considered, this equipment thus determining by itself the category of aircraft on which it is installed. This programming may alternatively be carried out in a software manner: the means of selection 13 receives for example through a data link a digital value which depends on the category of aircraft and it makes the selection as a function of this digital value received.

1-12. (canceled)

13. An aircraft terrain avoidance and alarm method, wherein:
I) in a preliminary step, at least one database (Bi, B1, B2, Bn) of performance of the aircraft is formed, which performance relates to an avoidance maneuver slope flyable by the aircraft, as a function of particular flight parameters, and, to form this database (Bi, B1, B2, Bn), a plurality of values are determined for said slope, representative on each occasion of different values as regards said flight parameters; and
II) in the course of a subsequent flight of the aircraft:
a) the effective values of said particular flight parameters are determined;
b) an avoidance trajectory is determined on the basis of these effective values of said particular flight parameters and of said database (Bi, B1, B2, Bn);
c) with the aid of said avoidance trajectory and of the profile of the terrain situated at least in front of the aircraft, a check is made to verify whether there is a risk of collision with said terrain for said aircraft; and
d) in case of risk of collision, a corresponding alarm signal is issued.

14. The method as claimed in claim 13, wherein said flight parameters comprise at least some of the following parameters of the aircraft:
its mass;
its speed;
its altitude;
the ambient temperature;
its centering;
the position of its main landing gear;
the aerodynamic configuration;
the activation of an air-conditioning system;
the activation of an anti-icing system; and
a possible failure of an engine.

15. The method as claimed in claim 13, wherein, for at least one flight parameter, a predetermined fixed value is used to form said database (Bi, B1, B2, Bn).

16. The method as claimed in claim 15, wherein use is made, as predetermined fixed value for a flight parameter, of the value of this flight parameter which exhibits the most unfavorable effect on the slope of the aircraft.

17. The method as claimed in claim 14, wherein use is made, for the speed, of a predetermined value corresponding to a stabilized minimum speed that the aircraft normally flies at during a terrain avoidance procedure.

18. The method as claimed in claim 14, wherein use is made, for the speed, of a predetermined value corresponding to a speed of best slope.

19. The method as claimed in claim 13, wherein, in case of failure of an engine, the slope of the aircraft is deduced from a nominal slope representative of normal operation of all the engines of the aircraft and to which is applied a deduction dependent on said nominal failure.

20. The method as claimed in claim 19, wherein said deduction is calculated by means of a polynomial function of said nominal slope.

21. An aircraft terrain avoidance and alarm device, said device (1) comprising:
a first means (2) knowing the profile of the terrain at least in front of the aircraft;
a second means (3) for determining an avoidance trajectory;
a third means (4) connected to said first and second means (2, 3), for verifying whether there exists a risk of collision of the terrain for the aircraft; and
a fourth means (7) for issuing an alarm signal, in case of detection of a risk of collision by said third means (4),
wherein it moreover comprises at least one database (Bi, B1, B2, Bn) of performance of the aircraft, relating to an avoidance maneuver slope flyable by the aircraft, as a function of particular flight parameters, said database (Bi, B1, B2, Bn) comprising a plurality of values for said slope, that are representative on each occasion of different values as regards said flight parameters, and a fifth means (9) for determining in the course of a flight of the aircraft the effective values of said particular parameters, and said second means (3) is formed in such a way as to determine said avoidance trajectory, as a function of cues received respectively from said database (Bi, B1, B2, Bn) and from said fifth means (9).

22. A device as claimed in claim 21, wherein it comprises a plurality of databases (Bi, B1, B2, Bn) relating respectively to various categories of aircraft and a means of selection (13) for selecting, from among these databases (Bi, B1, B2, Bn), the one which relates to the aircraft on which said device (1) is mounted, said second means (3) using cues from the database (Bi, B1, B2, En) thus selected to determine said avoidance trajectory.

23. An aircraft, wherein it comprises a device (1) able to implement the method specified under claim 13.

24. An aircraft, wherein it comprises a device (1) such as that specified under claim 21.
